(19) United States
(12) Patent Application Publication
(10) Pub. No.: US 2003/0212606 A1
(43) Pub. Date: Nov. 13, 2003

(54) Method for selectively providing digital goods to a consumer at a consumer client computer

(76) Inventors: Gary Adelman, New York, NY (US); Dan Brodsky, New York, NY (US)

Correspondence Address: LAW OFFICES OF JOSEPH F. MURPHY, 101 WEST 23 RD ST B, SUITE 2367, NEW YORK,, NY, 10011-2490, US

(21) Appl. No.: 10/144,499

(22) Filed: May 13, 2002

(51) Int. Cl. G06F 17/60

(52) U.S. Cl. 705/26

(57) ABSTRACT

A method for selectively providing digital goods to a consumer having a PIN number at a consumer client computer, comprising associating a PIN number as corresponding to at least one of said digital goods, and further comprising having said customer enter a PIN number into said consumer client computer, and still further comprising determining if said entered PIN number is a valid PIN number corresponding to said at least of one of said digital goods, whereby if it is a valid PIN number corresponding to said digital goods, digital goods are provided to said consumer.

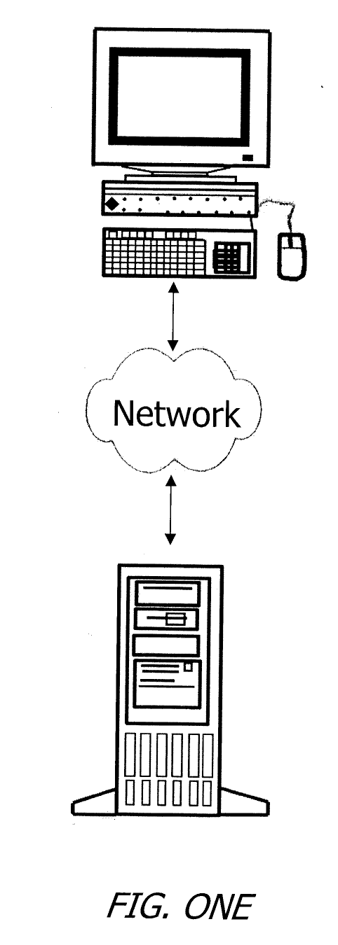

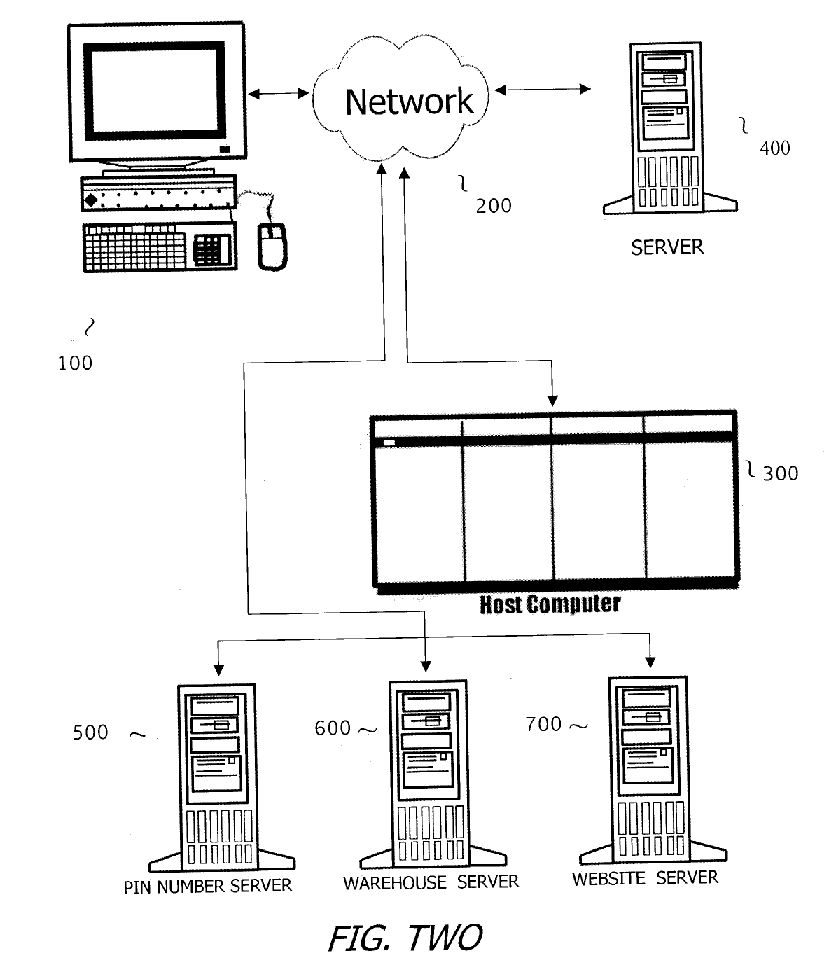

### STATEMENT OF THE PROBLEM

In recent years, the growth of the Internet has made possible the distribution of “digital goods”. These digital goods, which may comprise any item (e.g. a URL, audio file, web page, picture, etc.) contained as a flow of electronic information over the Internet, are typically delivered to a consumer at a “client” computer, from a larger “server” computer. The Consumer Client Computer may be virtually any device having or being operated in conjunction with a microprocessor (e.g. a Personal Computer, an MP3 player, a Palm Computer, etc.)

The Internet is widely noted for facilitating universal access to stored information or digital goods, and also for facilitating universal distribution of them. However, often the provider of the digital goods wishes to selectively provide or distribute digital goods, e.g. to provide/distribute them only to certain consumers. In prior art systems, this was primarily, if not exclusively, accomplished by securing such digital goods inside special “secure servers”. These secure servers, in addition to storing the digital goods content, also ran “validation” software making them accessible to Consumer Client Computers only upon if the consumer would enter a code such as, for example, a credit card number, or some other sort of alphanumeric code. This alphanumeric code would be passed to the special validation software, and, if validated, the secure server would provide the digital good to the Consumer Client Computer.

Notably, under the method typical of the prior art, this “validation” (access-control) software had to be located on the same server computer as the digital goods it controlled access to/distribution of. This meant that a digital goods provider could not selectively provide digital goods using his own computer (often, but not always, the one on which he placed his website), as such would not typically have the necessary validation/access-control software. In other words, it meant that the digital goods provider either had to (1) equip his server computer (which stored the digital goods) with the validation/access-control software, or (2) relinquish the digital goods to the operator of the larger server computer which had the validation/access control software therein. Neither option is desirable; in fact, both are far from ideal. It would be more desirable to separate the functions of digital goods provision and of access control/validation, as will be elaborated on in more detail later.

Thus, there is a need for access control/validation which can occur “virtually” at the Website Server Computer, that is, seemingly occurring at the Website Server Computer but actually occurring elsewhere, and thus eliminating the need, common in the prior art, to install and maintain special access control/validation software at the Website Server Computer. This avoids disadvantages common to prior art solutions which require the Website Server Computer operator (usually, if not always, the digital goods provider and/or one of its agents) to develop and implement and manage an entire access control system, often involving generating PIN numbers, validating them, etc., as well as storing or “warehousing” digital goods and doing all the other steps necessary for a method to distribute digital goods.

### SUMMARY OF THE INVENTION

The method of the present invention virtually outsources the validation function of digital goods distribution, freeing the providers/distributors of digital goods to concentrate their core business, i.e. that of producing and readying for distribution digital goods. In accordance with the method according to the present invention, the validation function is performed by software in a dedicated PIN Number Management Server Computer which is optimized to do the validation function, and thereby regulating the digital goods distribution function of at least one Warehouse Server Computer 600. Indeed, that same dedicated PIN Number Management Server Computer may provide the validation function for any number of a plurality of Warehouse Server Computers. This permits economies of scale in performing the validation function, as well as enabling the aggregation of data arising from the operation of more than one Warehouse Server Computer. Simplicity and cost-efficiencies are also achieved, as the specialized validation software only needs to be written, installed, and maintained on the single computer used to manage the PIN Numbers (i.e. the PIN Number Server Computer), and not on each and every computer on which the digital goods are stored (i.e. the Warehouse Server Computer) computer used.

According to another aspect of the present invention, effective distribution of the digital goods being distributed is encouraged by the dissemination of PIN numbers.

Thus, it is seen that method of the present invention solves all the aforementioned—and other—problems in a way that is strikingly simple, yet robustly effective, and which, moreover, offers numerous other advantages.

Simply stated, the method according to the present invention involves selectively providing digital goods to a consumer at Consumer Client Computer 100. The method involves having a PIN Number Managing Server Computer 500 to identify by PIN number digital goods (not shown, for clarity) for storage on a Warehouse Server Computer 600 in a fashion enabling the distribution of said digital goods to be managed by said PIN Number Managing Server Computer 500, working in conjunction with said Warehouse Server Computer 600 and said Website Server Computer 700. Furthermore, in accordance with a further novel method according to the present invention, an authorized party can collect data suitable to generate many different reports, including but not limited to data suitable to generate reports relating to the following: the actual or attempted download of digital goods using a particular PIN number or set of PIN numbers.

Moreover, in further accordance with the practice of the current invention an authorized party may process data so as to generate reports or analyses suitable for benchmarking, resale to consumer market data companies, etc.

### BRIEF DESCRIPTION OF THE DRAWING

FIG. ONE is an illustration of one approach of the prior art, where a client computer may access digital goods from a server computer.

FIG. TWO is an illustration of an exemplary system implementing the method of the present invention, which, in its presently preferred embodiment, utilizes the functionalities of a Network, a Consumer Client Computer, a PIN Number Management Server Computer, a Warehouse Server Computer and a Website Server Computer.

### DETAILED DESCRIPTION OF THE INVENTION

According to the presently preferred method of the current invention, selectively providing digital goods to a consumer having a PIN number at a Consumer Client Computer 100, comprises the steps of associating a PIN number as corresponding to at least one of said digital goods, storing said PIN number on a PIN Number Managing Server Computer 500, storing said digital goods on a Warehouse Server Computer 600, and configuring a Website Server Computer 700 to run a program which may receive a PIN number from said consumer. The method according to the present invention further comprises having said consumer enter a PIN number into said Consumer Client Computer 100, passing said PIN from said Consumer Client Computer 100 to said Website Server Computer 700 to request said digital goods and passing said PIN number from said Website Server Computer 700 to said PIN managing server computer 500. As is well-known and readily understood to those skilled in the art, said passing said PIN number may be accomplished via network 200, as may any other data transfer(s) according to the method of the present invention. In further accordance with the method according to the present invention, said PIN Number Managing Server Computer 500 determines if said entered PIN number is a valid PIN number is corresponding to said digital goods, whereby if it is a valid PIN number corresponding to said at least one of said digital goods, said PIN Number Managing Server Computer 500 authorizes said Warehouse Server Computer 600 to provide said digital goods to said consumer, and if it is not a valid PIN number corresponding to said digital goods, said PIN Number Managing Server Computer 500 does not authorize said Warehouse Server Computer 600 to provide said digital goods to said consumer. The method may further comprise the step of associating, with said PIN number, data of any type.

In accordance with the practice of the present invention, there is defined a set of Personal Identification Numbers (PIN)s comprising one or more numbers, usually integers. (Note that for the purpose of brevity, PINs herein are discussed as being numerical, it being understood that the “numbers” in a PIN are but one symbol which could be used, and that other symbols, such as letters, glyphs, alphanumerical symbols, etc., could also be used, either alone or in combination with numbers.).

A consumer comes to have a PIN in his or her possession or knowledge—either because it has been provided to him or her for use in accordance with the present invention, or because s/he is told a number already in his/her possession—such as a student ID number—is now useable as a PIN number (because it has been defined as such).

Next, the PIN number is entered into the Client Computer 100 (typically though not always, an individual's PC), which may be continuously or intermittently operatively connected, via network 200 (e.g. the Internet), to devices comprising any one or more of the following: PIN Number Managing Server Computer 500, Warehouse Server Computer 600, and the Network 200. Upon validation of the PIN, the digital good is dispensed, and the transaction continues according to the method of the current invention. (Note that the examples given herein are given in a non-limiting fashion, and other examples will be readily apparent to those of ordinary skill in the art.)

Heretofore, there has not been found any effective prior art solution that is as good as the method according to the present invention. No other method is known to be as effective in facilitating the distribution of digital goods, as disclosed herein. Thus, nothing is like the new solution offered by the method according to the present invention, which is low cost, easy to administer, and which solves problems without disadvantages of any of the known prior art.

It is also well known that computers are connectible via a network, and that said network may comprise or be coextensive with the Internet.

The foregoing detailed description should be regarded as illustrative rather than limiting and the appended claims including all equivalents are intended to define the scope of the invention.

I claim:

1) a method for selectively providing digital goods to a consumer having a pin number at a consumer client computer, comprising:
a) associating a PIN number as corresponding to at least one of said digital goods;
b) storing said PIN number on a PIN number managing server computer;
c) storing said digital goods on a warehouse server computer;
d) configuring a website server computer to run a program which may receive a PIN number entered by said consumer;
e) having said customer enter a PIN number into said consumer client computer, passing said PIN from website server computer to said website server computer to request said digital goods;
f) passing said PIN number from said website server to said PIN managing server computer;
g) said PIN managing server computer determining if said entered PIN number is a valid PIN number corresponding to said at least of one of said digital goods, whereby if it is a valid PIN number corresponding to said digital goods, said PIN managing server computer authorizes said warehouse computer to provide said digital goods to said consumer.

2) A method for selectively providing digital goods to a consumer having a PIN number at a consumer client computer, comprising:
a) associating a PIN number as corresponding to at least one of said digital goods;
b) storing said digital goods on a warehouse server computer;
c) configuring a website server computer to run a program which may receive a PIN number entered by said consumer;
d) having said customer enter a PIN number into said consumer client computer, passing said PIN from website server computer to said website server computer to request said digital goods;
e) passing said PIN number from said website server to said PIN managing server computer;
f) said PIN managing server computer determining if said entered PIN number is a valid PIN number corresponding to said at least of one of said digital goods, whereby if it is a valid PIN number corresponding to said digital goods, said PIN managing server computer authorizes said warehouse computer to provide said digital goods to said consumer, and if it is not a valid PIN number corresponding to said digital goods, said PIN number managing computer does not authorize said warehouse computer to provide said digital goods to said consumer.

3) A method for selectively providing digital goods to a consumer having a PIN number at a consumer client computer, comprising:
a) associating a PIN number as corresponding to at least one of said digital goods;
b) storing said PIN number on a PIN number managing server computer;
c) storing said digital goods on a warehouse server computer;
d) configuring a website server computer to run a program which may receive a PIN number entered by said consumer;
e) having said customer enter a PIN number into said consumer client computer, passing said PIN from website server computer to said website server computer to request said digital goods;
f) passing said PIN number from said website server to said PIN managing server computer;
g) said PIN managing server computer determining if said entered PIN number is a valid PIN number corresponding to said at least of one of said digital goods, whereby if it is a valid PIN number corresponding to said digital goods, said PIN managing server computer authorizes said warehouse computer to provide said digital goods to said consumer, and if it is not a valid PIN number corresponding to said digital goods, said PIN number managing computer does not authorize said warehouse computer to provide said digital goods to said consumer.
